(19) United States
(12) Patent Application Publication
(10) Pub. No.: US 2018/0088268 A1
(43) Pub. Date: Mar. 29, 2018

(54) LIGHT DIFFUSION PLATE

(71) Applicant: ASAHI GLASS COMPANY, LIMITED, Tokyo (JP)

(72) Inventors: Yuki KONDO, Tokyo (JP); Yuichi KUWAHARA, Tokyo (JP); Junko MIYASAKA, Tokyo (JP); Seiki OHARA, Tokyo (JP); Katsumi SUZUKI, Tokyo (JP)

(73) Assignee: ASAHI GLASS COMPANY, LIMITED, Tokyo (JP)

(21) Appl. No.: 15/828,670

(22) Filed: Dec. 1, 2017

Related U.S. Application Data
(63) Continuation of application No. PCT/JP2016/066401, filed on Jun. 2, 2016.

(30) Foreign Application Priority Data
Jun. 2, 2015 (JP) 2015-112646

(51) Int. Cl. F21V 8/00; G02B 5/02; C03C 3/085

(52) U.S. Cl. CPC G02B 6/0025; C03C 3/085; G02B 5/02

(57) ABSTRACT

The present invention relates to a light diffusion plate including a glass plate having a first main surface and a second main surface opposed to the first main surface, in which the glass plate has a thermal expansion coefficient of −100×10⁻⁷/° C. or more and 500×10⁻⁷/° C. or less, and light incident on the first main surface is transmitted from the second main surface while being diffused.

### TECHNICAL FIELD

The present invention relates to a light diffusion plate used for a direct type or an edge light type backlight unit of a liquid crystal television, a liquid crystal monitor or the like.

### BACKGROUND ART

When a transparent material is used as a material of a light diffusion plate used for a direct type backlight unit of a liquid crystal television, a liquid crystal monitor or the like, light is transmitted therethrough, which makes a light source visible. Therefore, materials that do not impair the brightness of the light source without making the shape of the light source behind the light diffusion plate visible are used. Here, the light source is a light emitting diode (LED) or the like.

In addition, when a transparent material is used as a material of a light diffusion plate used for an edge light type backlight unit of a liquid crystal television, a liquid crystal monitor or the like, the brightness of a light guide plate that emits light incident on the diffusion plate appears uneven. Therefore, materials that do not make the brightness of the light guide plate behind the light diffusion plate appear uneven are used. Since the light diffusion plates used for direct type backlight units also have similar problems, although a detailed explanation will be given below of an example using the direct type backlight unit, the diffusion plate is not limited to that used for the direct type backlight unit. In addition, the light diffusion plate may be read as a light diffusion sheet.

In the related art, as a material of a light diffusion plate, a material in which a thermoplastic resin forming a continuous phase is blended with polymeric or inorganic particles having a refractive index different from that of the thermoplastic resin as a dispersed phase is used (Patent Documents 1 and 2). In addition, Patent Document 3 discloses a light diffusion plate made of a polycarbonate resin whose diffusivity, reflectance and unevenness of brightness are in specific ranges.

### PRIOR ART DOCUMENT

### Patent Document

Patent Document 1: Japanese Patent No. 3748568
Patent Document 2: Japanese Patent No. 3100853
Patent Document 3: JP-A-2006-339033

### SUMMARY OF THE INVENTION

### Problems that the Invention is to Solve

In recent years, liquid crystal televisions, liquid crystal monitors and the like have shown a tendency to increase in size, and light diffusion plates used for direct type backlight units are required to have high brightness homogeneity and strength. In order to further improve the light diffusion performance and further reduce the thickness for design reasons, there is a demand to shorten the distance between the light source and the light diffusion plate.

However, since resin-made light diffusion plates of the related art have low heat resistance and light resistance, in the case where the distance between a light source and the light diffusion plate is made excessively short, there are problems in that the light diffusion plate deforms over time, the shape of the light source becomes conspicuously observed, it is difficult to maintain brightness homogeneity, and the like. Furthermore, since such resin-made light diffusion plates have large thermal expansion coefficient, it is necessary to secure space for expansion following increase in temperature and space for heat dissipation, making narrowing of the frame difficult. In addition, such resin-made light diffusion plates have low rigidity and there is a problem in that the strength of the outer frame has to be strengthened. Moreover, since such resin-made light diffusion plates have low water resistance, there is a problem in that resin-made light diffusion plates swell and deform when stored for a long period of time as a result of absorbing water entering from the periphery of the light diffusion plate.

With increasing in size of liquid crystal televisions, liquid crystal monitors and the like, these problems tend to cause in-plane temperature distribution or inflow distribution within the plane of moisture from outside air and tend to cause display unevenness through warpage of the resin-made light diffusion plate.

Accordingly, an object of the present invention is to provide a light diffusion plate used in a direct type backlight unit, which is suitable for thinning, frame narrowing and size increasing, which has high heat resistance, high light resistance and high water resistance, and which exhibits excellent rigidity and excellent display quality.

### Means for Solving the Problems

The inventors of the present invention found that it is possible to solve the problems described above by using, as a member of a light diffusion plate used for a direct type backlight unit, a glass plate having a first main surface and a second main surface opposed to the first main surface, in which light which is incident on the first main surface is transmitted from the second main surface while being diffused, and in which the glass plate has high heat resistance, high light resistance and high water resistance, has excellent rigidity, and has light diffusibility controlled in a specific range and a thermal expansion coefficient in a specific range, thereby completing the present invention.

That is, the present invention contains the following.

1. A light diffusion plate including a glass plate having a first main surface and a second main surface opposed to the first main surface, in which the glass plate has a thermal expansion coefficient of −100×10⁻⁷/° C. or more and 500×10⁻⁷/° C. or less, and light incident on the first main surface is transmitted from the second main surface while being diffused.
2. The light diffusion plate according to 1, in which the glass plate has a haze of 90% or more when incident light to the first main surface in a normal direction is transmitted through the glass plate, and has a ratio I₃₀/I₀ being 0.6 or more, of a transmittance I₀ at a wavelength of 550 nm of transmitted light in an incident direction and a transmittance I₃₀ at a wavelength of 550 nm of transmitted light in a direction tilted by 30° with respect to the incident direction.
3. The light diffusion plate according to 1 or 2, in which the glass plate includes light scatterers having an average particle diameter of 50 nm or more and 10,000 nm or less in an interior thereof, and the light scatterers have a difference (Dl−Ds) being 100 nm or more, between an average value Ds of a lower 10% and an average value DI of an upper 10% of a particle diameter in a frequency distribution of scattering particles of the light scatterers in a particle diameter of 50 nm or more.
4. The light diffusion plate according to any one of 1 to 3, in which the light scatterers occupy a volume fraction of 5% or more in the glass plate.
5. The light diffusion plate according to 1, in which the glass plate has, for incident light to the first main surface in the normal direction, a sum (Tt+Rt) being 90% or more, of an average value Tt of a total light transmittance and a total light reflectance Rt at a wavelength of from 400 nm to 700 nm of light transmitted in the incident direction.
6. The light diffusion plate according to 5, in which the glass plate has (a*²+b*²)^{1/2} of 10 or less in a 1976 CIE L*a*b* color system under a D65 light source.
7. The light diffusion plate according to any one of 1 to 6, in which the glass plate has a water absorption rate of less than 0.1% based on JIS K7209 (2000).
8. The light diffusion plate according to any one of 1 to 7, in which the glass plate has a glass transition point Tg of 200° C. or higher and 850° C. or lower.
9. The light diffusion plate according to any one of 1 to 8, in which the glass plate has a Young's modulus of 10 GPa or more and 500 GPa or less.
10. The light diffusion plate according to any one of 1 to 9, in which the glass plate has a Vickers hardness Hv of 300 or more and 900 or less.
11. The light diffusion plate according to any one of 1 to 10, in which the glass plate has a surface resistance value of 1.0×10¹⁵Ω/□ or less.
12. The light diffusion plate according to any one of 1 to 11, in which the glass plate contains, as indicated by molar percentages in terms of oxides, from 40% to 80% of SiO₂, from 0% to 35% of Al₂O₃, from 0% to 30% of MgO, from 0% to 30% of Na₂O, and from 0% to 15% of P₂O₅.
13. The light diffusion plate according to 12, in which the glass plate further contains, as ppm by weight in terms of oxides, from 1 to 2,000 ppm of Fe₂O₃ and from 0.01 to 30 ppm of CoO.
14. The light diffusion plate according to any one of 1 to 13, in which the glass plate has, for incident light to the first main surface in a normal direction, an average value being 4% or more, of a total light transmittance at a wavelength of from 400 nm to 700 nm transmitted in the incident direction.
15. The light diffusion plate according to any one of 1 to 14, in which the glass plate has a total light reflectance being 10% or more, in a wavelength range of from 400 nm to 700 nm for a plate thickness of 1 mm when incident light from the normal direction to the first main surface is transmitted through the glass plate.
16. The light diffusion plate according to any one of 1 to 15, in which the glass plate has a transmittance being 0.2% or more and 10% or less, at a wavelength of from 400 nm to 700 nm of transmitted light in a direction tilted by 30° with respect to the incident direction.
17. The light diffusion plate according to any one of 1 to 16, in which the glass plate has a plate thickness of 0.05 mm or more and 3 mm or less.
18. The light diffusion plate according to any one of 1 to 17, in which the glass plate has a dimension with at least one side of 200 mm or more.

### Advantageous Effect of the Invention

Since the light diffusion plate of the present invention includes a glass plate having light diffusibility controlled in a specific range, high heat resistance and high light resistance, in a case of being used for a direct type backlight unit, it is possible to shorten the distance between the light source and the light diffusion plate and it is easy to achieve brightness homogeneity, thinning and frame narrowing. In addition, since the light diffusion plate of the present invention includes a glass plate, as compared with a resin-made light diffusion plate, the rigidity is excellent, static electricity is not easily generated, and the surface has high hardness and is hardly scratched. Therefore, the light diffusion plate of the present invention is easily handled in the manufacturing steps in the case of being used for a direct type backlight.

Furthermore, owing to the use of a glass plate, the light diffusion plate of the present invention has higher water resistance as compared to a resin-made light diffusion plate. Therefore, even when stored for a long period of time in the case of being used in a direct type backlight, the light diffusion plate does not easily swell or deform and display unevenness does not easily occur.

### BRIEF DESCRIPTION OF DRAWINGS

FIG. 1 is a cross-sectional view of a direct type backlight unit using a light diffusion plate of the present invention.

FIG. 2 shows the evaluation results of transmittance wavelength dependency.

FIGS. 3A, 3B and 3C show the evaluation results of a transmitted light distribution. Light was made to be incident on a first main surface of a sample from a normal direction, the transmittance at each wavelength of 630 nm, 550 nm, and 450 nm was measured for light transmitted in the directions at 0°, 10, 2°, 3°, 4°, 5°, 6°, 7°, 8°, 9°, 10°, 20°, 30°, 40°, 500, 60°, 70°, and 80° on the same horizontal plane with respect to the normal line of the sample, and an angle is shown on a horizontal axis and the transmittance at that angle is shown on a vertical axis.

FIG. 4 is a diagram illustrating transmitted light diffusely transmitted through the light diffusion plate.

### MODE FOR CARRYING OUT THE INVENTION

The present invention relates to a light diffusion plate including a glass plate having a first main surface and a second main surface opposed to the first main surface, in which the glass plate has a thermal expansion coefficient of −100×10⁻⁷/° C. or more and 500×10⁻⁷/° C. or less, and light incident on the first main surface is transmitted from the second main surface while being diffused. The light diffusion plate of the present invention is effectively used as a member of a direct type backlight of a liquid crystal television, a liquid crystal monitor and the like.

The glass plate of the light diffusion plate of the present invention has a first main surface and a second main surface opposed to the first main surface. Here, the first main surface of the glass plate is the surface that becomes the light source side in the case of being used for a direct type backlight unit. The second main surface of the glass plate is a surface opposed to the first main surface and is a surface which becomes the liquid crystal panel side in the case of being used for a direct type backlight unit.

The light diffusion plate of the present invention transmits light incident on the first main surface from the second main surface while diffusing the light. Here, “transmits light incident on the first main surface from the second main surface while diffusing the light” means that appropriate light scattering properties are exhibited due to having an appropriate haze and transmittance light distribution, and that appropriate transparency are exhibited due to having an appropriate total light transmittance. The transmittance light distribution is the angular distribution when light is transmitted from the second main surface after the light incident on the first main surface is diffused inside the light diffusion plate. Having an appropriate transmittance light distribution means that it is possible to homogeneously disperse the transmitted light from the light source.

The light diffusion plate of the present invention contains light scatterers inside the glass plate. Since the light scatterers have different refractive index to that around the periphery thereof, the incident light is scattered. In the case where there are dispersed phases inside the glass plate and there are continuous phases at the periphery thereof, the dispersed phases are called light scatterers. In addition, in the case where there are continuously entangled phases inside the glass plate, a phase with a small volume fraction is called a light scatterer. In the case where a large number of light scatterers are present inside the glass plate, the light incident from the light source is repeatedly scattered and it is possible to homogeneously disperse the transmitted light.

The light diffusion performance of the light diffusion plate depends on the size of the light scatterers. In order to express the size of the light scatterer, the size and the average value of the size of the light scatterers are respectively referred to as the particle diameter and the average particle diameter of the scatterers, and are defined below. In the case where the light scatterer is spherical, the particle diameter is defined by the diameter thereof. In the case where the light scatterer is not spherical, the particle diameter of the light scatterer is defined by a value obtained by dividing the sum of the long side and short side of the cross-section of the light scatterer by two. In the case where the light scatterers are continuously entangled phase, the particle diameter of the light scatterer is defined by the width of the phase. The average particle diameter of the light scatterer is defined by a value obtained by averaging particle diameters of the light scatterers inside the glass plate.

In order to reduce the wavelength dependency of the light scattering property, the average particle diameter of the light scatterers is preferably 50 nm or more, more preferably 75 nm or more, even more preferably 100 nm or more, still more preferably 125 nm or more, particularly preferably 150 nm or more, yet more preferably 175 nm or more, and most preferably 200 nm or more. In order to improve the light scattering property, the average particle diameter is preferably 10,000 nm or less, more preferably 7,500 nm or less, even more preferably 5,000 nm or less, still more preferably 4,000 nm or less, particularly preferably 3,000 nm or less, and most preferably 2,000 nm or less. The average particle diameter is typically 200 nm or more or 2,000 nm or less. The average particle diameter of the light scatterers can be measured by SEM observation.

Specifically, it is possible to obtain a light diffusion plate in which light incident to the first main surface is transmitted from the second main surface while being diffused by including a glass with separated phases (also referred to as phase-separated glass) or a crystallized glass as the glass plate. This is because the phase-separated glass and the crystallized glass have properties of exhibiting an appropriate light scattering property due to possessing an appropriate haze and transmittance light distribution, and exhibiting appropriate transparency due to possessing an appropriate total light transmittance.

The phase separation of glass means that a single-phase glass is divided into two or more glass phases. Examples of a method of causing phase separation of glass include a method of subjecting the glass to a heat treatment.

Typically, as a condition for the heat treatment for phase separation of glass, the temperature is preferably a temperature 50° C. higher, more preferably a temperature 75° C. higher and particularly preferably a temperature 100° C. higher, than the glass transition point. However, as a condition for heat treatment, typically, the temperature is preferably a temperature up to 400° C. higher, more preferably a temperature up to 350° C. higher and particularly preferably a temperature up to 300° C. higher, than the glass transition point.

The time for the heat treatment of glass is preferably from 1 to 64 hours, and more preferably from 2 to 32 hours. From the viewpoint of mass productivity, the time is preferably 24 hours or less, and more preferably 12 hours or less. In order to cause phase separation of glass in a shorter time, it is preferable to use a glass having a phase separation temperature of 1,000° C. or higher and to carry out heat treatment at 1,000° C. or higher. The time for the heat treatment is 5 seconds or more in order to control the size of the phase separation structure. The time is preferably 10 seconds or more, more preferably 1 minute or more, and even more preferably 30 minutes or more. A long heat treatment time is not good for optical characteristics. The heat treatment time is preferably 10 hours or less, more preferably 8 hours or less, even more preferably 6 hours or less, still more preferably 4 hours or less, particularly preferably 2 hours or less, and most preferably 1 hour or less.

It is possible to determine whether glass is phase-separated or not by using a scanning electron microscope (SEM). That is, in the case where glass is phase-separated, phase separation into two or more phases can be observed when observing with SEM.

The state of the phase separation of glass include a binodal state and a spinodal state. The binodal state is phase separation due to the nucleation-growth mechanism, and is generally spherical. The spinodal state is a state in which separated phases are mutually and continuously entangled in three dimensions having regularity to a certain extent. These separated phases exhibit the function as a light scatterer.

In the glass plate used for the light diffusion plate of the present invention, the phase functioning as light scatterers inside the glass plate in a phase separated state has an average particle diameter of preferably from 50 to 10,000 nm, and more preferably from 100 to 5,000 nm. Specifically, in order to reduce the wavelength dependency of the light scattering property, the average particle diameter of the above phase is preferably 50 nm or more, more preferably 75 nm or more, even more preferably 100 nm or more, still more preferably 125 nm or more, particularly preferably 150 nm or more, yet more preferably 175 nm or more, and most preferably 200 nm or more. In order to improve the light scattering property, the average particle diameter of the above phase is preferably 10,000 nm or less, more preferably 7,500 nm or less, even more preferably 5,000 nm or less, still more preferably 4,000 nm or less, particularly preferably 3,000 nm or less, and most preferably 2,000 nm or less. The average particle diameter of the above phase is typically 200 nm or more and 2,000 nm or less. The average particle diameter of the above phase can be measured by SEM observation.

Here, in the spinodal state, the average particle diameter in the phase separated state is an average value of the width of the phases which are mutually and continuously entangled phases with a small volume fraction. On the other hand, in the binodal state, the average particle diameter in the phase separated state is an average value of the diameter in the case where one phase is spherical and is an average value of the value obtained by dividing the sum of the long diameter and the short diameter by two in the case where one phase is an oval sphere.

In order to further reduce the wavelength dependency of the light scattering property and to obtain a good transmittance light distribution, the light scatterers preferably has a distribution in the particle diameter. Excluding particles of less than 50 nm whose contribution to the optical characteristics in the visible region is small, the difference (Dl−Ds) between the average value Ds of the lower 10% and the average value DI of the upper 10% in the particle diameters (nm) measured by the SEM observation, is preferably 100 nm or more, more preferably 200 nm or more, even more preferably 400 nm or more, still more preferably 700 nm or more, particularly preferably 1,000 nm or more, and most preferably 2,000 nm or more.

It is possible to control the particle diameter distribution in the glass, for example, by controlling the thermal history of the phase separation process. As an example, it is possible to generate a particle diameter distribution in the plate thickness direction by imparting a temperature difference between the upper surface, inside and lower surface of the glass. Examples of heating methods for imparting the temperature difference in the upper surface, inside and lower surface of the glass, include changing the temperature or number of the heating heaters arranged on the upper surface and the lower surface side of the glass or changing the distance between the heaters and glass plates, using localized heating using induction heating or a laser, or the like. In addition, in the case of performing the phase separation treatment on a glass in a molten state, it is possible to obtain the same effect by controlling the flow velocity distribution in the plate thickness direction.

In addition, in order to impart a uniform particle diameter distribution in the thickness direction of the glass, it is sufficient to control the time spent passing through the temperature range for the phase separation treatment. The particle diameter increases as the glass slowly passes through the temperature range for the phase separation treatment, and the particle diameter decreases as the glass passes through quickly. A method for controlling the time spent passing through the temperature range for the phase separation treatment may be, for example, a method of precisely controlling the temperature profile of the heat treatment furnace, or may be also achieved by controlling the flow velocity of the glass if phase separation is performed in the course of passing through the glass forming process.

In addition, in order to exhibit an appropriate light scattering property due to possessing an appropriate haze, it is preferable that the difference in refractive index between one phase and the phase around the periphery thereof in the phase-separated glass is large. The refractive index difference is preferably 0.0001 or more, more preferably 0.001 or more, even more preferably 0.01 or more, particularly preferably 0.03 or more, and most preferably 0.06 or more. However, in the case where the refractive index difference is excessively large, the diffusion performance will be excessively high and the transparency will be poor, thus the refractive index difference is preferably 0.3 or less, more preferably 0.2 or less, even more preferably 0.16 or less, particularly preferably 0.14 or less, and most preferably 0.12 or less. The refractive index difference can be estimated with the Appen formula using the composition analysis result according to SEM-EDAX or a wet method.

In order to exhibit an appropriate light scattering property due to possessing an appropriate haze, the phase functioning as light scatterers inside the glass in the phase-separated glass preferably occupies 5% or more of the volume fraction in the glass plate, more preferably 10% or more, even more preferably 15% or more, particularly preferably 20% or more, particularly preferably 25% or more, and most preferably 30% or more. Here, the ratio of the volume of the particles in the dispersed phase is estimated from the ratio of the dispersed particles by calculating the ratio of the dispersed particles distributed on the glass surface from an SEM observation photograph.

The method for manufacturing the phase-separated glass is not particularly limited. However, for example, it may be performed by blending suitable amounts of various raw materials, heating them to about from 1,500° C. to 1,800° C. to melt them, then performing homogenization by defoaming, stirring or the like, followed by forming into a plate shape or the like by a known float method, a drawing down method, a press method, a roll-out method, or the like, or forming into a block shape by casting, then, annealing the shaped one, processing it into an arbitrary shape, and then subjecting it to a phase separation treatment.

Here, in the present invention, phase-separated glass also includes glass which is phase separated by a heat treatment for melting, homogenizing, forming, annealing, or shape processing without performing a specific phase separating treatment in steps such as melting, homogenizing, forming, annealing, or shape processing of the glass. The step of phase-separating the glass is included in the melting step or the like in such cases.

Crystallized glass is a glass in which a fine crystal phase is precipitated inside glass, has high mechanical strength and hardness, and has excellent characteristics of heat resistance, electrical characteristics and chemical durability, and the crystal phase exhibits a function as light scatterers. However, in the case of a light diffusion plate made of crystallized glass in the related art, there are problems in the control of the transmittance light distribution and the coloring of the light diffusion plate itself, and in light resistance, which are important when realizing an excellent display quality while shortening the distance between the light source and the light diffusion plate.

Examples of the crystallized glass used for the glass plate in the light diffusion plate of the present invention include the following (1) to (9):

(1) Crystallized glass containing nepheline solid solution crystal;
(2) Crystallized glass containing lithium disilicate (Li₂Si₂O₅), enstatite (MgSiO₃) and wollastonite (CaSiO₃);
(3) Crystallized glass containing aluminosilicate crystals such as Li₂O—Al₂O₃—SiO₂, MgO—Al₂O₃—SiO₂ and Al₂O₃—SiO₂ having a crystal phase including stuffed β-quartz, β-lysia pyroxene, cordierite, and mullite;
(4) Fluoro silicates such as alkali and alkaline earth micas and chain silicates such as potassium richterite and canasite;
(5) Crystallized glass containing oxide crystals in silicate host glasses such as glass-ceramics based on spinel solid solutions [e.g., (Zn, Mg) Al₂O₄] and quartz (SiO₂);
(6) CaO—Al₂O₃—SiO₂ based or CaO—Al₂O₃ based crystallized glass having a property where needle-like crystals precipitate and grow from the surface toward the inside while softening and deforming when a heat treatment is carried out at a temperature equal to or higher than the softening point;
(7) Crystallized glass obtained by melting, forming and heat-treating a glass containing SiO₂, Al₂O₃, MgO, ZnO, B₂O₃, Na₂O, and TiO₂ as main components;
(8) Crystallized glass containing enstatite (MgSiO₃) and diopside (MgCaSi₂O); and
(9) Crystallized glass containing enstatite (MgSiO₃), garnite (ZnO.Al₂O₃) and rutile (TiO₂).

The crystallized glass has a degree of crystallization of preferably 1% or more, more preferably 5% or more, and even more preferably 10% or more. In addition, the degree of crystallization is preferably 90% or less, more preferably 60% or less, even more preferably 40% or less, even more preferably 30% or less, and still more preferably 20% or less.

By controlling the degree of crystallization of the crystallized glass to 1% or more, it is possible to lower a thermal expansion coefficient, to obtain sufficient scattering characteristics, to increase Young's modulus, and to increase Vickers hardness. In addition, by adjusting the degree of crystallization of the crystallized glass to 90% or less, it is possible to obtain sufficient rigidity and to improve productivity.

The degree of crystallization C of the crystallized glass is calculated using the following equation using a and b, in which a is a ratio of the X-ray diffraction intensity of a reference sample and of a crystal that is the main component of the crystallized glass to be measured, the ratio a is obtained by performing X-ray diffraction measurement by adding crystals other than the crystals that are the main components of the crystallized glass to be measured to the crystallized glass to be measured as the reference sample, and in which b is a mass ratio of the reference sample and the crystallized glass:

C=A×a×(b/1−b).

Here, A is a constant referred to as Reference Intensity Ratio (RIR), and a value shown by Powder Diffraction File PDF-2 Release 2006 which is a database based on International Centre for Diffraction Data (http://www.icdd.com/) is used.

The average particle diameter in the crystallized glass is preferably 50 nm or more, more preferably 100 nm or more, and even more preferably 200 nm or more. In addition, the average particle diameter is preferably 10,000 nm or less, more preferably 50,000 nm or less, and even more preferably 20,000 nm or less.

Here, the average particle diameter in the crystallized glass is an average value of the diameter in the case where the dispersed crystal phases are spherical, is an average value of the values obtained by dividing the sum of the long diameter and the short diameter by 2 in the case of an oval spherical shape, and an average value of the values obtained by dividing the sum of the long side and the short side of the cross-section of the crystal phase by 2 in the case of a non-spherical sphere.

By controlling the average particle diameter in the crystallized glass to 50 nm or more, appropriate light scattering properties can be exhibited due to possessing an appropriate haze. In addition, by controlling the average particle diameter to 10,000 nm or less, appropriate transparency can be exhibited due to possessing an appropriate total light transmittance. The average particle diameter of the crystallized glass can be measured by a scanning electron microscope (also referred to as SEM).

From the viewpoint of exhibiting an appropriate light scattering property due to possessing an appropriate haze, it is preferable that the refractive index difference between the crystal phase in the crystallized glass and the amorphous glass phase of the periphery thereof is large. The refractive index difference is preferably 0.0001 or more, more preferably 0.001 or more, and even more preferably 0.01 or more. The refractive index difference can be estimated from the difference between the refractive index of the crystal based on the crystal data and the refractive index of the residual glass estimated with the Appen formula using the composition analysis value of the residual glass phase.

From the viewpoint of exhibiting an appropriate light scattering property due to possessing an appropriate haze, the volume ratio of the crystal phase in the crystallized glass is preferably 10% or more, and more preferably 20% or more. Here, the volume ratio of the crystal phase is estimated from the ratio of the crystal phase by calculating the ratio of the crystal phase distributed on the glass surface from an SEM observation photograph.

In order to further reduce the wavelength dependency of the light scattering property, the crystal phases preferably has a distribution in the particle diameter. Excluding particles of less than 50 nm whose contribution to the optical characteristics in the visible region is small, the difference (Dl−Ds) between the average value Ds of the lower 10% and the average value Dl of the upper 10% in the particle diameters (nm) measured by the SEM observation, is preferably 100 nm or more, more preferably 200 nm or more, even more preferably 400 nm or more, still more preferably 700 nm or more, particularly preferably 1,000 nm or more, and most preferably 2,000 nm or more.

It is possible to control the crystal distribution in the glass, for example, by controlling the thermal history of the crystallization process. As an example, it is possible to generate a particle diameter distribution in the plate thickness direction by imparting a temperature difference between the upper surface, inside and lower surface of the glass. Examples of heating methods for imparting the temperature difference in the upper surface, inside and lower surface of the glass, include changing the temperature or number of the heating heaters arranged on the upper surface and the lower surface side of the glass or changing the distance between the heaters and glass plates, using localized heating using induction heating or a laser, or the like.

In addition, in the case of performing the crystallization treatment on a glass in a molten state, it is possible to obtain the same effect by controlling the flow velocity distribution in the plate thickness direction. In addition, in order to impart a uniform particle diameter distribution in the thickness direction of the glass, it is sufficient to control the time spent passing through the temperature range for the crystallization treatment. The particle diameter increases as the glass slowly passes through the crystallization temperature range, and the particle diameter decreases as the glass passes quickly. A method for controlling the time spent passing through the crystallization temperature range may be, for example, a method of precisely controlling the temperature profile of a heat treatment furnace, or may be also achieved by controlling the flow velocity of the glass if crystallization is carried out in the course of passing through a glass forming process.

From the viewpoints of productivity and cost, the glass plate in the light diffusion plate of the present invention has a thermal expansion coefficient of −100×10⁻⁷/° C. or more, preferably −10×10⁻⁷/° C. or more, more preferably 1×10⁻⁷/° C. or more, and even more preferably 50×10⁻⁷/° C. or more. The thermal expansion coefficient is 500×10⁻⁷/° C. or less, preferably 300×10⁻⁷/° C. or less, more preferably 200×10⁻⁷/° C. or less, and even more preferably 150×10⁻⁷/° C. or less.

By controlling the thermal expansion coefficient of the glass plate within the above range, it is possible to suppress deformation when the distance between the light source and the light diffusion plate is made excessively short in order to improve the light diffusion performance, the shape of the light source becomes less conspicuously observed, and brightness homogeneity can be achieved. In addition, extra space in anticipation of deformation is unnecessary and it is possible to address frame narrowing and thinning.

In the present invention, “thermal expansion coefficient” means a value measured in accordance with ISO 7991 (1987). The thermal expansion coefficient of the glass plate can be controlled by the glass composition, precipitated crystal seed, degree of crystallization, degree of phase separation, heat treatment temperature, cooling rate, and the like.

The glass plate in the light diffusion plate of the present invention preferably has a water absorption rate of less than 0.1%, more preferably 0.01% or less, and even more preferably 0.001% or less. By controlling the water absorption rate of the glass plate to less than 0.1%, there is no concern about swelling by absorbing water in the case of being used for a direct type backlight unit. Therefore, it is possible to maintain the performance even when stored for a long period of time. In addition, the light diffusion plate does not easily warp, display unevenness is reduced, and the display quality is improved.

In the present invention, the water absorption rate is a value measured in accordance with JIS K 7209 (2000).

The glass plate in the light diffusion plate of the present invention preferably has a glass transition point Tg of 200° C. or more, more preferably 300° C. or more, even more preferably 400° C. or more, and even more preferably 500° C. or more. In addition, the glass transition point Tg is preferably 850° C. or less, more preferably 800° C. or less, even more preferably 750° C. or less, and even more preferably 700° C. or less.

In the case where the glass plate has the glass transition point Tg of 200° C. or higher, the glass plate is not easily deformed by heat. Therefore, it is possible to shorten the distance between the light source and the light diffusion plate in the case of being used for a direct type backlight unit, and brightness homogeneity is easily achieved as compared to resin-made light diffusion plate. In addition, in the case where the glass transition point is 850° C. or lower, the productivity of the glass is improved.

In the present invention, the term “glass transition point” means the temperature corresponding to the bending point in a thermal expansion curve obtained by measuring the elongation percentage of the glass when increasing the temperature from room temperature at a rate of 5° C./min to the yield point by using a differential thermal expansion meter and using quartz glass as a reference sample.

The glass plate in the light diffusion plate of the present invention preferably has a yield point of 200° C. or more, more preferably 300° C. or more, and even more preferably 400° C. or more. The yield point is usually preferably 950° C. or lower. In the case where the glass plate has a yield point of 200° C. or more, the heat resistance is excellent and brightness homogeneity is easily achieved as compared to a resin-made light diffusion plate. The yield point of the glass plate can be measured by a method described below in Examples.

The glass plate in the light diffusion plate of the present invention preferably has a Young's modulus of 10 GPa or more, more preferably 20 GPa or more, even more preferably 50 GPa or more, and even more preferably 70 GPa or more. In addition, the Young's modulus is preferably 500 GPa or less, more preferably 200 GPa or less, and even more preferably 150 GPa or less.

In the case where the glass plate has a Young's modulus of 10 GPa or more, excellent rigidity can be obtained and the glass plate is easily handled in the case of being used for a direct type backlight unit, as compared to a resin-made light diffusion plate. In addition, in the case where the Young's modulus is 500 GPa or less, excellent productivity is obtained.

The glass plate in the light diffusion plate of the present invention preferably has a Vickers hardness Hv of 300 or more, more preferably 400 or more, and even more preferably 500 or more. In addition, The Vickers hardness Hv is preferably 900 or less, more preferably 800 or less, and even more preferably 750 or less.

In the case where the glass plate has a Vickers hardness Hv of 300 or more, it is possible to prevent the glass plate from being damaged by a member between the light source and the light diffusion plate. In addition, in the case where the Vickers hardness Hv is 900 or less, the glass is easily processed.

The Vickers hardness Hv of the glass plate can be measured by the Vickers hardness test described in Japanese Industrial Standard JIS Z 2244 (2009).

The glass plate in the light diffusion plate of the present invention preferably has a bending strength of 10 MPa or more, more preferably 20 MPa or more, even more preferably 30 MPa or more, and particularly preferably 100 MPa or more. In the case where the glass plate has a bending strength of 10 MPa or more, excellent rigidity can be obtained and the glass plate is easily handled in the case of being used for a direct type backlight unit, as compared to a resin-made light diffusion plate. In addition, the bending strength of the glass plate is usually 300 MPa or less. The bending strength of the glass plate can be measured by a method described below in Examples.

In the where it is desired to make the light diffusion plate of the present invention thinner, it is preferable to carry out ion exchange with a molten salt with larger cations than that contained in the glass, to thereby form compressive stress on the surface. In the case of glass containing Na₂O, it is preferable to carry out the ion exchange with potassium nitrate. The compressive stress is preferably 100 MPa or more, more preferably 300 MPa or more, and particularly preferably 500 MPa or more.

The glass plate in the light diffusion plate of the present invention preferably has a surface resistance value of 10⁵Ω/□ or more, more preferably 10⁷Ω/□ or more, even more preferably 10⁹Ω/□ or more, and yet more preferably 10¹¹Ω/□ or more. In addition, the surface resistance value is preferably 1.0×10¹⁵Ω/□ or less, more preferably 1.0×10¹⁴Ω/□ or less, and even more preferably 1.0×10¹³Ω/□ or less.

In the case where the glass plate has a surface resistance value of 10⁵Ω/□ or more, the leakage current is reduced to improve safety. In addition, in the case where the surface resistance value is 1.0×10¹⁵Ω/□ or less, static electricity is hardly generated and the glass plate is easily handled as compared to a resin-made light diffusion plate. The surface resistance value of the glass plate can be measured by the method described in JIS K 6911 (2006).

The desired characteristics (thermal expansion coefficient, water absorption rate, glass transition point, yield point, Young's modulus, Vickers hardness, bending strength, and surface resistance value) of the glass plate in the light diffusion plate of the present invention can be appropriately adjusted by the glass composition, heat treatment conditions (e.g., conditions for phase separation treatment in the case of a phase-separated glass, conditions for crystallization treatment in the case of a crystallized glass, etc.), and the like.

Specifically, in the case where the glass is a phase-separated glass, it is possible to obtain a diffusion plate having optical characteristics suitable for a light diffusion plate in terms of light transmittance and light diffusibility, by employing, for example, the glass composition and phase separation treatment conditions in the following ranges.

### (Glass Composition)

In terms of molar percentage, preferably, SiO₂ is from 50% to 70%, Al₂O₃ is from 0% to 8%, a total amount of MgO, CaO and BaO is from 0% to 20%, Na₂O is from 0% to 15%, P₂O₅, is from 0% to 8%, B₂O₃ is from 0% to 8%, and ZrO₂ is from 0% to 5%.

### (Phase Separation Treatment Conditions)

A temperature from 50° C. to 400° C. higher than the glass transition point is preferable. The temperature is more preferably from 100° C. to 300° C. higher. The time for applying heat treatment on the glass is preferably from 1 to 64 hours, and more preferably from 2 to 32 hours. From the viewpoint of mass productivity, the time is preferably 24 hours or less, and more preferably 12 hours or less.

In addition, in the case where the glass is a crystallized glass, it is possible to obtain a diffusion plate having optical characteristics suitable for a light diffusion plate in terms of light transmittance and light diffusibility, by employing, for example, the glass composition and crystallization conditions in the following range.

### (Glass Composition)

In terms of molar percentages, SiO₂ is from 45% to 80%, Al₂O₃ is from 0% to 28%, Na₂O is from 0% to 20%, K₂O is from 0% to 10%, and TiO₂ is from 2% to 10%.

### (Crystallization Conditions)

(1) As a condition of the heat treatment for generating nuclei in the glass after the raw glass is initially heated to a temperature within or slightly higher than the transition range, the temperature is preferably 950° C. or less, and more preferably 900° C. or less. The heat treatment time is preferably from 1 to 10 hours, and more preferably from 2 to 6 hours.
(2) As a condition of the heat treatment for growing crystals on the nucleus formed in (1) by heating the glass to a higher temperature, sometimes to a temperature higher than the softening point thereof, the temperature is preferably from 850° C. to 1,200° C., and more preferably from 900° C. to 1,150° C. The heat treatment time is preferably from 1 to 10 hours, and more preferably from 2 to 6 hours.

The glass plate in the light diffusion plate of the present invention preferably has a haze of 90% or more when incident light to the first main surface in a normal direction is transmitted through the glass plate, more preferably 93% or more, and even more preferably 96% or more. In the case where the haze is 90% or more, appropriate diffusibility can be ensured in the case where the glass plate is used for a direct type backlight unit.

The haze can be measured in accordance with the method described in JIS K7136 (2000).

The glass plate of the light diffusion plate of the present invention has an average value of a linear transmittance at a wavelength of from 400 nm to 700 nm transmitted in an incident direction in the incident light from the normal direction to the first main surface, being preferably 15% or less, more preferably 10% or less, and even more preferably 5% or less. In the case where the average value of the linear transmittance is 15% or less, brightness unevenness hardly occurs in the case where the light diffusion plate is used for a direct type backlight unit.

The linear transmittance depends on the thickness of the glass plate. The thickness of the glass plate of the present invention is set as the thickness of the target light diffusion plate and the linear transmittance at the thickness of the light diffusion plate is taken as the linear transmittance.

The average value of the linear transmittance can be calculated from the following formula by measuring the linear transmittance Ts for each 1 nm wavelength in a wavelength range of from 400 nm to 700 nm.

$${\sum }_{n = 400}^{700} Tsn / ( 700 - 400 + 1 )$$

In the above formula, n is an integer of from 400 to 700.

The linear transmittance of a glass plate at a wavelength of from 400 nm to 700 nm can be measured by normal transmittance measurement.

In order to achieve the brightness necessary for the backlight, the glass plate of the light diffusion plate of the present invention has an average value of a total light transmittance at a wavelength range of from 400 nm to 700 nm transmitted in an incident direction in the incident light from the normal direction to the first main surface, being preferably 4% or more, more preferably 5% or more, even more preferably 10% or more, particularly preferably 20% or more, and most preferably 30% or more.

In addition, if the average value of the total light transmittance is 90% or less, the diffusibility is not impaired. The average value is preferably 85% or less, more preferably 80% or less, even more preferably 75% or less, yet more preferably 70% or less, still more preferably 65% or less, particularly preferably 60% or less, and most preferably 55% or less.

The average value of the total light transmittance can be calculated from the following formula by measuring the total light transmittance Tt for each 1 nm wavelength in a wavelength range of from 400 nm to 700 nm.

$${\sum }_{n = 400}^{700} Ttn / ( 700 - 400 + 1 )$$

In the above formula, n is an integer of from 400 to 700.

The total light transmittance of the glass at a wavelength of from 400 nm to 700 nm can be measured with a spectrophotometer or the like.

In the present invention, two types of transmittance (linear transmittance Ts and total light transmittance Tt) are described. The differences therebetween in definitions will be described. When light strikes an object, a part of the light is reflected, a part of the light entering into the object is absorbed by the object, and the remainder is emitted as a transmitted light. The transmittance of this transmitted light is defined as the total light transmittance Tt. The transmitted light of the total light is divided into diffused transmitted light diffused by the object and linear transmitted light traveling linearly in the incident direction, and the transmittance of the linear transmitted light is defined as the linear transmittance Ts.

The glass plate of the light diffusion plate of the present invention has a total light reflectance Rt in a wavelength range of from 400 nm to 700 nm when an incident light from the normal direction to the first main surface is transmitted through the glass plate, being preferably 10% or more, more preferably 20% or more, even more preferably 25% or more, and still more preferably 30% or more. In addition, the total light reflectance Rt is preferably 96% or less, more preferably 95% or less, and even more preferably 90% or less.

In the case where the total light reflectance Rt is 10% or more when the incident light from the normal direction to the first main surface is transmitted through the glass plate, brightness unevenness hardly occurs in the case where the light diffusion plate is used for a direct type backlight unit. In addition, in the case where the total light reflectance Rt is 90% or less, it is possible to achieve the brightness necessary for the backlight. The sum (Tt+Rt) of Tt and Rt is preferably 90% or more, more preferably 95% or more, and even more preferably 98% or more. In the case where Tt+Rt is 90% or more, it is possible to suppress the attenuation of light in the light diffusion plate, and homogeneous and sufficient brightness as a backlight unit can be achieved.

In the present invention, the total light reflectance when incident light from the normal direction to the first main surface is transmitted through the glass plate means an average value of the reflectance of each wavelength measured in the wavelength range of from 400 nm to 700 nm. The total light reflectance can be measured with a spectrophotometer or the like.

The total light reflectance depends on the thickness of the glass plate. The thickness of the glass plate of the present invention is set as the thickness of the target light diffusion plate and the total light reflectance at the thickness of the light diffusion plate is taken as the total light reflectance.

The average value of the total light reflectance can be calculated from the following formula by measuring the total light reflectance Rt for each 1 nm wavelength in a wavelength range of from 400 nm to 700 nm.

$${\sum }_{n = 400}^{700} {R}_{tn} / ( 700 - 400 + 1 )$$

In the above formula, n is an integer of from 400 to 700.

The total light reflectance of the glass at a wavelength of from 400 nm to 700 nm can be measured with a spectrophotometer or the like.

The glass plate in the light diffusion plate of the present invention has a light transmittance at a wavelength of from 400 nm to 700 nm of the transmitted light of light incident from the normal direction to the first main surface and transmitted at a direction tilted by 30° with respect to the normal line of the glass plate, being preferably 0.2% or more, more preferably 0.3% or more, and even more preferably 0.4% or more. In addition, the transmittance is also preferably 10% or less, more preferably 8% or less, and even more preferably 5% or less.

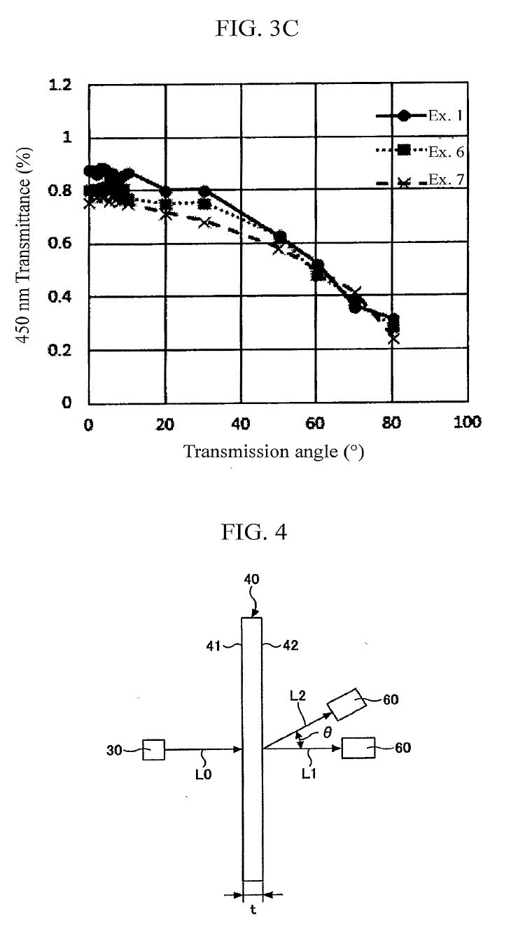

FIG. 4 is a diagram illustrating transmitted light diffusely transmitted through the light diffusion plate. A light diffusion plate 40 having a thickness t diffuses and transmits light from the light source 30 from one of the two opposed main surfaces 41 and 42 to the other. Below, in the two main surfaces 41 and 42, the main surface 41 on the light source 30 side is referred to as a light irradiation surface 41 and the main surface 42 on the side opposite to the light source 30 is referred to as a light-emitting surface 42 in some cases.

In FIG. 4, L0 represents irradiation light orthogonally incident on the light irradiation surface 41, L1 represents transmitted light (referred to below as “linear transmitted light”) whose emission direction is the same direction as the incident direction, and L2 represents transmitted light (referred to below as “diffused transmitted light”) whose emission direction is tilted by 30° with respect to the incident direction. The angle θ formed by the light ray of the linear transmitted light L1 and the light ray of the diffused transmitted light L2 is 30°. When the transmittances at a wavelength of 550 nm transmitted in directions at 0° and 30° are measured and set as I₀ and I₃₀, respectively, I₃₀/I₀ provides an index of the transmittance light distribution which is important for good diffusivity. Here, I₃₀/I₀ is preferably 0.6 or more, more preferably 0.7 or more, and even more preferably 0.8 or more. Similarly, when the transmitted light at a wavelength of 450 nm transmitted in the directions at 0° and 30° is measured and set as I₀ and I₃₀, respectively, I₃₀/I₀ is preferably 0.6 or more, more preferably 0.7 or more, and even more preferably 0.8 or more. In addition, similarly, when transmitted light at a wavelength of 630 nm transmitted in the directions of 00 and 30° is measured and set as I₀ and I₃₀, respectively, I₃₀/I₀ is preferably 0.6 or more, more preferably 0.7 or more, and even more preferably 0.8 or more.

The intensity I₀ of the linear transmitted light L1 and the intensity I₃₀ of the diffused transmitted light L2 are measured by a photometer 60. The photometer 60 is pivoted between a position for measuring the intensity I₀ of the linear transmitted light L1 and a position for measuring the intensity ho of the diffused transmitted light L2. For the intensity ho of the diffused transmitted light L2, an average value of the measured values at a plurality of points may be adopted, or a measured value at any one point may be adopted.

In the case where the light transmittance at a wavelength of from 400 nm to 700 nm of the transmitted light of light incident from the normal direction to the first main surface and transmitted at a direction tilted by 30° with respect to the normal line of the glass plate, is 0.2% or more, necessary brightness for a backlight can be achieved. In addition, in the case where the transmittance is 10% or less, appropriate diffusibility can be secured.

In the present invention, the transmittance at a wavelength of from 400 nm to 700 nm of the transmitted light of light incident from the normal direction to the first main surface and transmitted at a direction tilted by 30° with respect to the normal line of the glass plate, is measured by a spectrophotometer or the like.

The transmittance at a wavelength of from 400 nm to 700 nm of the transmitted light of light incident from the normal direction to the first main surface and transmitted at a direction tilted by 30° with respect to the normal line of the glass plate, depends on the thickness of the glass plate. The thickness of the glass plate of the present invention is set as the thickness of the target light diffusion plate and the transmittance at the thickness of the light diffusion plate is taken as the transmittance.

The glass plate in the light diffusion plate of the present invention has a ratio (total light reflectance/total light transmittance) of the total light reflectance and total light transmittance in a wavelength range of from 400 nm to 700 nm when incident light from the normal direction to the first main surface passes through the glass plate, being preferably 0.25 or more, more preferably 0.3 or more, and even more preferably 0.4 or more. In the case where the ratio is 0.25 or more, brightness necessary for a backlight can be achieved. The upper limit is not particularly limited, but it is usually preferably 4 or less, more preferably 3 or less, and particularly preferably 2 or less.

The desired optical characteristics (haze, linear transmittance, and total light reflectance) of the glass plate in the light diffusion plate of the present invention can be appropriately adjusted by the glass composition, heat treatment conditions (e.g., conditions for phase separation treatment in the case of phase-separated glass, conditions for crystallization treatment in the case of crystallized glass, etc.), and the like.

Specifically, in the case where the glass plate is a phase-separated glass, it is possible to adjust the average value of the linear transmittance at a wavelength of from 400 nm to 700 nm transmitted in an incident direction in the incident light from the normal direction to the first main surface, to 15% or less, by employing, for example, the glass composition and phase separation treatment conditions in the following ranges.

### (Glass Composition)

In terms of molar percentages based on oxides, preferably, SiO₂ is from 50% to 70%, Al₂O₃ is from 1% to 8%, the total amount of MgO, CaO and BaO is from 0% to 20%, Na₂O is from 1% to 15%, P₂O₅ is from 0.5% to 8%, B₂O₃ is from 0% to 8%, and ZrO₂ is from 0% to 5%.

### (Phase Separation Treatment Conditions)

A temperature from 50° C. to 400° C. higher than the glass transition point is preferable. The temperature is more preferably from 100° C. to 300° C. higher. The time for applying heat treatment on the glass is preferably from 1 to 64 hours, and more preferably from 2 to 32 hours. From the viewpoint of mass productivity, the time is preferably 24 hours or less, and more preferably 12 hours or less.

In addition, in the case where the glass plate is a crystallized glass, it is possible to adjust the average value of the linear transmittance at a wavelength of from 400 nm to 700 nm transmitted in an incident direction in the incident light from the normal direction to the first main surface, to 15% or less, by employing, for example, the glass composition and crystallization conditions in the following range.

### (Glass Composition)

In terms of molar percentages based on oxides, preferably, SiO₂ is from 45% to 60%, Al₂O₃ is from 15% to 28%, Na₂O is from 10% to 20%, K₂O is from 1% to 10%, and TiO₂ is from 5% to 10%.

### (Crystallization Conditions)

(1) As a condition of the heat treatment for generating nuclei in the glass after the raw glass is initially heated to a temperature within or slightly higher than the transition range, the temperature is preferably 950° C. or less, and more preferably 900° C. or less. The heat treatment time is preferably from 1 to 10 hours, and more preferably from 2 to 6 hours.
(2) As a condition of the heat treatment for growing crystals on the nucleus formed in (1) by heating the glass to a higher temperature, sometimes to a temperature higher than the softening point thereof, the temperature is preferably from 850° C. to 1,200° C., and more preferably from 900° C. to 1,150° C. The heat treatment time is preferably from 1 to 10 hours, and more preferably from 2 to 6 hours.

In addition, in the case where the glass plate is a phase-separated glass, it is possible to adjust the total light reflectance at a wavelength of from 400 nm to 700 nm transmitted in an incident direction in the incident light from the normal direction to the first main surface, to 10% or more, by adjusting the average particle diameter of the dispersed phase of the phase-separated glass to from 0.2 μm to 5 μm.

The glass plate in the light diffusion plate of the present invention may have an uneven surface on the surface of the first main surface to increase the light diffusibility of the light diffusion plate. In the case where the surface of the first main surface has an uneven surface, the first main surface has an arithmetic mean roughness (Ra) of, though the lower limit thereof is not particularly limited, preferably 0.05 nm or more, and more preferably 0.1 nm or more in order to improve the light diffusibility of the light diffusion plate. In addition, though the upper limit is also not particularly limited, the arithmetic mean roughness (Ra) is preferably 10,000 nm or less, more preferably 7,000 nm or less, even more preferably 3,000 nm or less, particularly preferably 2,000 nm or less, and most preferably 1,000 nm or less. In order to reduce the influence of scratches generated during handling, the arithmetic mean roughness (Ra) is preferably 10 nm or more, more preferably 100 nm or more, even more preferably 1,000 nm or more, and most preferably 5,000 nm or more.

The arithmetic mean roughness Ra of the first main surface of the glass plate can be adjusted by selecting abrasive grains, a polishing method, or the like. In addition, the first main surface and the second main surface of the glass plate may be coated with silica, titania, alumina, or the like.

The arithmetic mean roughness Ra of the first main surface of the glass plate can be measured in accordance with Japanese Industrial Standard JIS B 0601 (1994). On the other hand, the arithmetic mean roughness Ra of the second main surface of the glass plate is also not particularly limited, and may be the same as or different from that of the first main surface.

A description will be given of the composition of the glass plate. In the present specification, the contents of the glass components will be described by using molar percentages unless otherwise specified.

SiO₂ is a basic component forming a network structure of glass. That is, SiO₂ develops an amorphous structure and exhibits excellent mechanical strength, weather resistance, or gloss as glass. The content of SiO₂ is preferably from 40% to 80%.

In the case where the content of SiO₂ is adjusted to 40% or more, the weather resistance and scratch resistance of glass are improved. The content of SiO₂ is more preferably 50% or more, even more preferably 55% or more, particularly preferably 60% or more, and most preferably 66% or more. On the other hand, by adjusting the content of SiO₂ to 80% or less, the productivity of the glass can be improved. The content of SiO₂ is more preferably 75% or less, even more preferably 73% or less, and particularly preferably 72% or less.

The content of Al₂O₃ is preferably from 0% to 35%. The content of Al₂O₃ being 0% to 35% means that Al₂O₃ does not need to be contained, but, in the case where Al₂O₃ is contained, the content thereof must be 35% or less (the same applies below).

Al₂O₃ has effects of not only improving the chemical durability of the glass and lowering the thermal expansion rate, but also significantly improving the dispersion stability of SiO₂ with other components and functioning to make the phase separation of the glass uniform. Since these effects are easily exhibited by adjusting the content of Al₂O₃ to 0.5% or more, the Al₂O₃ content is preferably 0.5% or more, more preferably 1% or more, and even more preferably 4% or more in the case where Al₂O₃ is contained.

If the content of Al₂O₃ is excessively large, the melting temperature of the glass becomes high, phase separation does not easily occur, and the linear transmittance increases. The content of Al₂O₃ is more preferably 28% or less, more preferably 20% or less, even more preferably 10% or less, particularly preferably 8% or less, yet more preferably 6% or less, still more preferably 5% or less, and most preferably 4% or less.

The content of MgO is preferably from 0% to 30%. Since MgO lowers the thermal expansion rate of glass and has an effect of promoting phase separation in combination with SiO₂ and Na₂O, it is preferable to contain MgO in the case where a phase-separated glass is used for the glass plate. The content of MgO is more preferably 5% or more, even more preferably 9% or more, particularly preferably 13% or more, and most preferably 15% or more.

By adjusting the content of MgO to 30% or less, it is possible to stabilize the glass. The content of MgO is more preferably 27% or less, even more preferably 25% or less, particularly preferably 24% or less, and most preferably 18% or less.

Here, MgO is preferably contained in an amount of more than 10% when considered in terms of mass percentage. In the case where MgO is contained more than 10%, the solubility can be improved. The MgO content is preferably 12% or more.

In addition, the ratio MgO/SiO₂ of the MgO content to the SiO₂ content is preferably 0.14 or more and 0.45 or less, and more preferably 0.15 or more and 0.40 or less. By adjusting Mg/SiO₂ to 0.14 or more and 0.45 or less, an effect of promoting phase separation and improving whiteness can be exhibited.

The content of Na₂O is preferably from 0% to 30%. In the case where Na₂O is contained, the meltability of the glass can be improved. In the case of containing Na₂O, the content thereof is preferably 1% or more, more preferably 2% or more, even more preferably 4% or more, and particularly preferably 8% or more. The content of Na₂O is more preferably 15% or less, even more preferably 14% or less, and particularly preferably 13% or less.

In the case where the content of Na₂O is 1% or more, it is possible to obtain the effects of containing Na₂O. In addition, by adjusting the content of Na₂O to 30% or less, the weather resistance of the glass can be improved.

Since P₂O₅ is a basic component promoting phase separation in combination with SiO₂, MgO and Na₂O, P₂O₅ is preferably contained in the case where a phase-separated glass is used for the glass plate in the light diffusion plate of the present invention. In the case of containing P₂O₅, the content of P₂O₅ is preferably 0.5% or more, more preferably 1% or more, even more preferably 3% or more, and particularly preferably 4% or more. The content of P₂O₅ is preferably 15% or less, more preferably 14% or less, even more preferably 10% or less, particularly preferably 7% or less, and most preferably 4.5% or less.

In the case where the content of P₂O₅ is adjusted to 0.5% or more, the light diffusion function can be sufficiently obtained. In addition, in the case where the content of P₂O₅ is adjusted to 15% or less, volatilization hardly occurs and brightness unevenness also hardly occurs in the case of being used in a light diffusion plate.

In the case where the content of SiO₂ is from 66% to 72%, the content of Al₂O₃ is preferably from 0% to 4%, the content of MgO is preferably from 16% to 24%, and the content of Na₂O is preferably from 4% to 10%.

In the case where the content of SiO₂ is 58% or more and less than 66%, the content of Al₂O₃ is preferably from 2 to 6%, the content of MgO is preferably from 11% to 18%, the content of Na₂O is preferably from 8% to 13%, and the content of P₂O₅ is preferably from 3% to 7%.

In the case where the content of SiO₂ is from 60% to 73%, the content of Al₂O₃ is preferably from 0% to 5%, the content of MgO is preferably from 13% to 30%, the content of Na₂O is preferably from 0% to 13%, and the content of P₂O₅ is preferably from 0.5% to 4.5%.

In the glass plate used for the light diffusion plate of the present invention, in addition to the above five components, it may be suitable to include the following components in some cases. Also in this case, the total content of the five components is preferably 90% or more, and typically 94% or more.

ZrO₂ is not an essential component. However, in order to remarkably improve the chemical durability, ZrO₂ is preferably contained in an amount of 4.5% or less, more preferably 4% or less, and even more preferably 3% or less. By adjusting the content of ZrO₂ to 4.5% or less, it is possible to prevent deterioration in the light diffusion function.

CaO, SrO and BaO are not essential components. However, in order to improve the light diffusion function, one or more of these components are preferably contained in an amount of 0.2% or more, more preferably 0.5% or more, and even more preferably 1% or more.

In the case where CaO is contained, the content thereof is preferably 3% or less. By adjusting the content of CaO to 3% or less, the glass becomes difficult to devitrify.

The total content of CaO, SrO, and BaO is preferably 12% or less, more preferably 8% or less, 6% or less or 4% or less, and typically 3% or less. By adjusting the total content to 12% or less, the glass becomes difficult to devitrify.

B₂O₃ is not an essential component, but may be contained in an amount of up to 9%, preferably 6% or less, more preferably 4% or less, and particularly preferably 3% or less, in order to increase the meltability of the glass, improve the whiteness of the glass, lower the thermal expansion rate, and further improve the weather resistance. In the case where the content of B₂O₃ is adjusted to 9% or less, brightness unevenness hardly occurs in the case of being used as a light diffusion plate. In particular, in order to promote the phase separation and improve the light diffusion function, the content of B₂O₃ is preferably 5% or more, more preferably 8% or more, even more preferably 10% or more. In order to improve the chemical durability, the content of B₂O₃ is preferably 20% or less and more preferably 15% or less.

La₂O₃ is suitable for improving the light diffusion function of the glass, and it can be contained in an amount of from 0% to 5%, preferably 3% or less, and more preferably 2% or less. By adjusting the content of La₂O₃ to 5% or less, it is possible to prevent the glass from becoming brittle.

In addition to the above components, the glass plate used in the light diffusion plate of the present invention may contain other components as long as the purpose of the present invention is not impaired. For example, Co, Mn, Fe, Ni, Cu, Cr, V, Zn, Bi, Er, Tm, Nd, Sm, Sn, Ce, Pr, Eu, Ag, or Au may be contained as coloring components. In such a case, typically, the total content of these coloring components is preferably 5% or less in terms of the molar percentage based on minimum valence oxides.

In order to facilitate homogeneous dissolution of the molten glass, Fe₂O₃ can be contained in an amount of 1 ppm or more, by weight ppm, more preferably 10 ppm or more, even more preferably 20 ppm or more, and even more preferably 30 ppm or more. By adjusting the content of Fe₂O₃ to 5,000 ppm or less, more preferably 3,000 ppm or less, even more preferably 2,000 ppm or less, and still more preferably 1,500 ppm or less, it is possible to prevent an excessive decrease in transmittance.

From the viewpoint of controlling the color of the glass, in weight ppm, CoO can be contained in an amount of 0.01 ppm or more, more preferably 0.05 ppm or more, and even more preferably 0.1 ppm or more. By adjusting the content of CoO to 30 ppm or less, more preferably 25 ppm or less, even more preferably 20 ppm or less, and still more preferably 10 ppm or less, it is possible to prevent an excessive decrease in transmittance.

Examples of the glass plate used for the light diffusion plate of the present invention include glass having the compositions described in the following (1) to (12):

(1) Glass containing, as indicated by molar percentages based on oxides, from 50% to 80% of SiO₂, from 0% to 10% of Al₂O₃, from 11% to 30% of MgO, from 0% to 15% of Na₂O, and from 0.5% to 15% of P₂O₅;
(2) Glass containing, as indicated by molar percentages based on oxides, from 66% to 72% of SiO₂, from 0% to 4% of Al₂O₃, from 16% to 24% of MgO, from 4% to 10% of Na₂O, and from 0.5% to 15% of P₂O₅;
(3) Glass containing, as indicated by molar percentages based on oxides, 58% or more and less than 66% of SiO₂, from 2% to 6% of Al₂O₃, from 11% to 18% of MgO, from 8% to 13% of Na₂O, and from 3% to 7% of P₂O₅;
(4) Glass containing, as indicated by molar percentages based on oxides, from 60% to 73% of SiO₂, from 0% to 5% of Al₂O₃, from 13% to 30% of MgO, from 0% to 13% of Na₂O, and from 0.5% to 4.5% of P₂O₅;
(5) Glass containing, as indicated by molar percentages based on oxides, from 50% h to 72% of SiO₂, from 0% to 8% of B₂O₃, from 1% to 8% of Al₂O₃, from 0% to 18% of MgO, from 0% to 7% of CaO, from 0% to 10% of SrO, from 0% to 12% of BaO, from 0% to 5% of ZrO₂, from 5% to 15% of Na₂O, and from 2% to 10% of P₂O₅, in which the total content of CaO, SrO and BaO is from 1% to 20%, the total content RO of MgO, CaO, SrO, and BaO is from 6% to 25%, and the ratio of CaO/RO of CaO content and RO is 0.7 or less;
(6) Glass containing, as indicated by molar percentages based on oxides, from 50% to 70% of SiO₂, from 0% to 8% of B₂O₃, from 1% to 8% of Al₂O₃, from 0% to 18% of MgO, from 0% to 7% of CaO, from 0% to 10% of SrO, from 0% to 12% of BaO, from 0% to 5% of ZrO₂, from 5% to 15% of Na₂O, and from 2% to 10% of P₂O₅, in which the total content of CaO, SrO and BaO is from 1% to 15%, the total content RO of MgO, CaO, SrO, and BaO is from 10% to 25%, and the ratio of CaO/RO of CaO content and RO is 0.7 or less;
(7) Glass containing, as indicated by molar percentages based on oxides, from 50% to 72% of SiO₂, from 0% to 8% of B₂O₃, from 1% to 8% of Al₂O₃, from 0% to 18% of MgO, from 0% to 7% of CaO, from 0% to 10% of SrO, from 0% to 12% of BaO, from 0% to 5% of ZrO₂, from 5% to 15% of Na₂O, and from 2% to 10% of P₂O₅, in which the total content of CaO, SrO and BaO is from 1% to 20%, the total content RO of MgO, CaO, SrO, and BaO is from 6% to 25%, and the ratio of CaO/RO of CaO content and RO is 0.7 or less;
(8) Glass containing, as indicated by molar percentages based on oxides, from 50% to 70% of SiO₂, from 0% to 8% of B₂O₃, from 1% to 8% of Al₂O₃, from 0% to 18% of MgO, from 0% to 7% of CaO, from 0% to 10% of SrO, from 0% to 12% of BaO, from 0% to 5% of ZrO₂, from 5% to 15% of Na₂O, and from 2% to 10% of P₂O₅, in which the total content of CaO, SrO and BaO is from 1% to 15%, and the total content RO of MgO, CaO, SrO, and BaO is from 10% to 25%;
(9) Glass containing, as indicated by molar percentages based on oxides, from 40% to 70% of SiO₂, from 15% to 30% of Al₂O₃, from 10% to 30% of Na₂O, and from 5% to 15% of K₂O (requiring a nepheline crystal component);
(10) Glass containing, as indicated by mass percentages based on oxides, from 40% to 80% of SiO₂, from 15% to 28% of Al₂O₃, from 0% to 8% of B₂O₃, from 1% to 8% of Li₂O, from 0% to 10% of Na₂O, from 0% to 11% of K₂O, from 0% to 16% of MgO, from 0% to 18% of CaO, from 0% to 10% of F, from 0% to 20% of SrO, from 0% to 12% of BaO, from 0% to 8% of ZnO, from 0% to 8% of P₂O₅, from 0% to 8% of TiO₂, from 0% to 5% of ZrO₂, and from 0% to 1% of SnO₂ (requiring a spodumene crystal component);
(11) Glass containing, as indicated by mass percentages based on oxides, from 40% to 75% of SiO₂, from 5% to 30% of CaO, and from 3% to 35% of Al₂O₃ (CaO center value being 17); and
(12) Glass containing, as indicated by mass percentages based on oxides, from 50% to 65% of SiO₂, from 10% to 25% of CaO, from 3% to 15% of Al₂O₃, and from 2% to 10% of ZnO.

The glass plate used for the light diffusion plate of the present invention has a plate thickness of 0.05 mm or more in order to maintain the strength and exhibit the appropriate functions as a light diffusion plate. The plate thickness is preferably 0.1 mm or more, more preferably 0.3 mm or more, even more preferably 0.4 mm or more, and particularly preferably 0.5 mm or more. The plate thickness is 2 mm or less. By setting the plate thickness of the glass plate to 0.05 mm or more, in order to sufficiently weaken the stress caused by the temperature distribution in the plate thickness direction due to heat from the light source, the plate thickness is 3 mm or less. The plate thickness is preferably 2.8 mm or less, more preferably 2.5 mm or less, even more preferably 2.3 mm or less, still more preferably 2.1 mm or less, and particularly preferably 2.0 mm or less.

The glass plate used for the light diffusion plate of the present invention has a dimension on at least one side of preferably 200 mm or more, more preferably 400 mm or more, and even more preferably 600 mm or more. In addition, this dimension is preferably 2,500 mm or less, more preferably 2,200 mm or less, even more preferably 2,000 mm or less, and particularly preferably 1,800 mm or less. By setting the dimension on at least one side of the glass plate to 200 mm or more, it is possible to provide a diffusion plate making use of the rigidity of the glass.

From the viewpoint of the wavelength spectrum of the emission line of an LED used as the light source, regarding the wavelength dependency of the total light transmittance of the glass plate used in the light diffusion plate of the present invention, it is preferable that the total light transmittance of the light diffusion plate has a wavelength dependency such that light transmitted through the light diffusion plate and other optical sheets is white, and it is even more preferable that the color of the light diffusion plate itself is also controlled.

In order to suppress changes in color of the light source due to light absorption by the light diffusion plate, the glass plate used for the light diffusion plate preferably has a (a*²+b*²)^{1/2} of 10 or less, more preferably 5 or less, even more preferably 3 or less, and particularly preferably 2 or less, in the L*a*b* color specification system when using a D65 light source, standardized by the International Commission on Illumination (CIE) and, in Japan, standardized in JIS (JIS X 8729).

The wavelength dependency of the total light transmittance of the glass plate used for the light diffusion plate of the present invention can be appropriately adjusted by the glass composition, heat treatment conditions (e.g., conditions for phase separation treatment in the case of a phase-separated glass, crystallization conditions in the case of a crystallized glass, etc.) and the like. Specifically, for example, in the case where the blue color of the light source is strong, a crystallized glass and a phase-separated glass are preferable from the viewpoint of suppressing the blue color, and a crystallized glass is more preferable. For example, in the case of a light source excellent in whiteness, it is desirable that the light diffusion plate itself be white and thus, a phase-separated glass is more preferable.

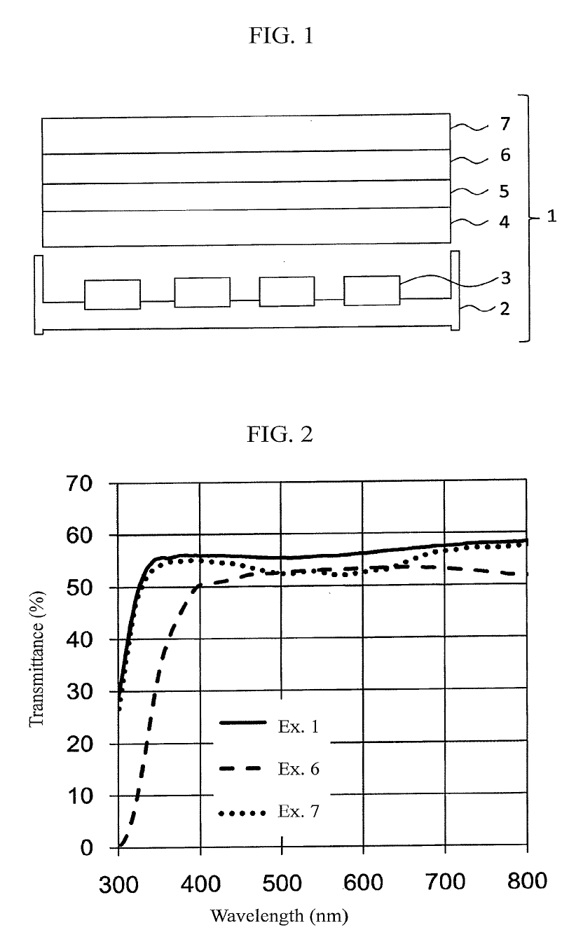

The light diffusion plate of the present invention can be suitably used for a direct type backlight unit of a liquid crystal television, a liquid crystal monitor or the like. FIG. 1 illustrates a cross-sectional view of a direct type backlight unit using the light diffusion plate of the present invention. In the direct type backlight unit 1 illustrated in FIG. 1, a light source 3 is provided at a predetermined interval above a reflecting plate 2, and a light diffusion plate 4 is provided thereabove. Light emitted from the light source 3 is diffused by the light diffusion plate 4.

A light diffusion sheet 5, a prism sheet 6, and a polarized light separation sheet 7 are provided in this order on the light diffusion plate 4. Although not illustrated in FIG. 1, an electromagnetic wave shielding sheet for shielding electromagnetic waves emitted from the light source may be provided between the light diffusion plate 4 and the light diffusion sheet 5.

The light diffusion plate of the present invention can be imparted the function as a light diffusion sheet by coating a glass plate with particles having a particle diameter of 100 nm or more, porous silica, or the like. In the case where the light diffusion plate of the present invention is imparted the function of the light diffusion sheet 5, the light diffusion sheet 5 can be omitted.

Since the light diffusion plate of the present invention has excellent heat resistance and light resistance, and controlled light diffusibility and transmittance light distribution, in the case of being used in a direct type backlight unit, it is possible to improve the homogenization of the brightness by shortening the distance between the light source and the light diffusion plate. Therefore, the light diffusion plate of the present invention can increase the homogenization of brightness as compared with the resin-made light diffusion plates of the related art. Specifically, the distance between the light source and the light diffusion plate is preferably less than 10 mm.

### Examples

### [Production of Glass]

### Examples 1 to 9, 16 to 19

Glass raw materials were appropriately selected, melted at 1,650° C., homogenized, and defoamed. After cooling the mixture to a phase separation treatment temperature at a cooling rate of 50° C. per minute, the mixture was kept at the phase separation treatment temperature for 30 minutes, poured into a mold, held at a temperature 30° C. higher than the glass transition temperature for 1 hour, and then cooled to room temperature at a cooling rate of 1° C. per minute. The phase separation of the glass was observed by SEM.

### Examples 10 to 15, 20 to 22

Glass raw materials were appropriately selected and weighed and mixed so as to be 300 g as glass. Then, the mixture was placed in a platinum crucible, charged in a resistance heating type electric furnace at 1,650° C., melted for 3 hours, defoamed, and homogenized, then poured into a mold, held at a temperature approximately 30° C. higher than the glass transition point for 1 hour, and then cooled to room temperature at a cooling rate of 1° C. per minute. The obtained glass was subjected to heat treatment under predetermined crystallization conditions to obtain a crystallized glass. The heating and cooling were carried out at 10° C. per minute.

### [Evaluation Method]

The obtained samples of Examples 1 to 22 were analyzed by the following evaluation method.

### (1) Specific Gravity

The specific gravity was measured by using Archimedes' principle.

### (2) Glass Transition Point (Tg)

The glass transition point was measured by TMA.

### (3) Yield Point

The yield point was determined by preparing a columnar glass test piece of diameter of from 3 to 5 mm×length of 20 mm, measuring the thermal expansion, and measuring the temperature at the apex of the expansion curve.

### (4) Thermal Expansion Coefficient

The average thermal expansion coefficient at 50° C. to 350° C. was measured by using a differential thermomechanical analyzer (TMA) and determined in accordance with JIS R3102 (FY 1995).

### (5) Young's Modulus

The Young's modulus was measured by an ultrasonic pulse method for a glass plate having a thickness of from 4 to 10 mm and a size of about 40 mm×40 mm.

### (6) Vickers Hardness

The Vickers hardness was measured by the Vickers hardness test described in Japanese Industrial Standard JIS Z 2244 (2009).

### (7) Bending Strength

The bending strength was measured by a three-point bending test at room temperature under the conditions of a crosshead speed of 0.5 mm/min and a support stand span of 30 mm, by using a glass plate mirror-polished with cerium oxide on both surfaces of a sample having a shape of 40 mm×5 mm×1 mm.

### (8) Surface Resistance

The surface resistance value was measured by using an insulation meter (SM-8220, manufactured by DKK-TOA Corporation) and an electrode for a flat plate sample (SME-8311, manufactured by DKK-TOA Corporation) in accordance with JIS K 6911 (2006).

### (9) Haze

The haze value was measured by a method in accordance with JIS K7136 (2000) by a haze meter (Haze meter HZ-2, manufactured by Suga Test Instruments Co., Ltd.).

### (10) Linear Transmittance Ts, Total Light Transmittance Tt, and Total Light Reflectance Rt

For the total light transmittance, the linear transmittance, the total light transmittance, and the total light reflectance at a wavelength of from 400 nm to 800 nm were acquired with an ultraviolet-visible near-infrared spectrophotometer (LAMBDA 950, manufactured by PerkinElmer Co., Ltd.) by using a mirror-finished glass plate having a thickness (1 mm or 5 mm) shown in Table 1 with the upper and lower surfaces thereof being mirror finished. Tt+Rt was calculated from the obtained values.

### (11) Crystallization Ratio

Al₂O₃ (corundum) crystals having a degree of crystallization of 100% were added as reference samples to the samples of Examples 11 to 22 and X-ray diffraction measurement was performed by using an X-ray diffractometer (RINT-TTR III, manufactured by RIGAKU Corporation), to calculate the crystallization ratio from the mass ratios of the reference sample and the samples of Examples 11 to 15 and the ratio of the respective X-ray diffraction line intensities.

### (12) Transmittance Light Distribution

The transmittance light distribution was measured with an ultraviolet-visible-infrared spectrophotometer (V-670DS, manufactured by JASCO Corporation) and an automatic absolute reflectance measuring unit (ARMN-735, manufactured by JASCO Corporation). Light was made to be incident on the first main surface of the sample from the normal direction, and the transmittance at wavelengths of from 400 nm to 700 nm was measured for each light transmitted on the same horizontal plane with respect to the normal line of the sample in the directions at 0°, 1*, 2°, 3°, 4°, 50, 6°, 7°, 8°, 9°, 10°, 20°, 30°, 40°, 50°, 60°, 70°, and 80°. The transmittances at a wavelength of 550 nm of light transmitted in the directions at 0° and 30° were measured and set as I₀ and I₃₀, respectively. I₃₀/I₀ was calculated from these values.

### (13) Particle Diameter

After optically polishing the glass surface, the glass surface was observed with a scanning electron microscope (SEM). Excluding particles of less than 50 nm whose contribution to the optical characteristics in the visible region is small, for particle diameters measured for 30 or more arbitrarily selected particles, the average value Da, the average value Ds of the lower 10%, the average value Dl of the upper 10%, and the difference therebetween (Dl−Ds) were calculated.

### (14) Color

A sample having a thickness of 1 mm and having mirror-finished upper and lower surfaces was prepared. For chromatic (a*, b*) values indicating hue and saturation, measurement was carried out in accordance with the L*a*b* color system measurement standardized by the International Commission on Illumination (CIE) and also standardized in Japan as JIS (JIS X 8729), by placing 1 mm thick glass on a white base [EVERS Corporation., EVER-WHITE (Code No. 9582)] where L*=98.44, a*=−0.20, and b*=0.23 and using a colorimeter (Chroma Meter CR 400, manufactured by Konica Minolta, Inc.) with a D65 light source.

### (15) Visual Evaluation of Diffusibility

The diffusion plate used in VIERA TH-32D300, manufactured by Panasonic Corporation was changed to the light diffusion plate of Examples 1 to 22 to prepare backlight units for diffusibility evaluation. The diffusibility was evaluated visually with criteria that cases where the shape of the LED was not visually recognizable were evaluated as A and cases where the shape was visually recognizable were evaluated as B.

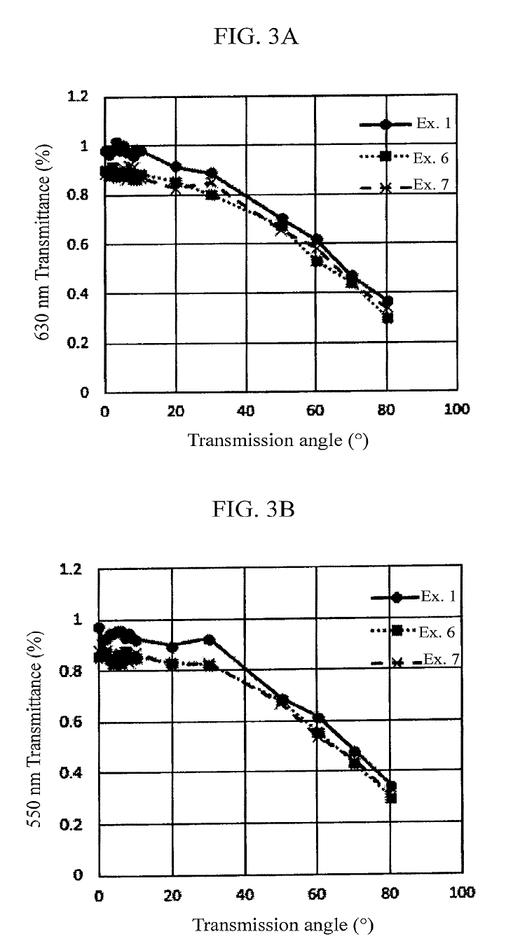

The results are shown in Tables 1 to 6. In Tables 1 to 6, “-” and blanks indicate that there was no evaluation. In addition, for Examples 1, 6, and 7, the results of evaluating the transmittance wavelength dependency are shown in FIG. 2 and the results of evaluating the transmitted light distribution are shown in FIGS. 3A, 3B and 3C.

TABLE 1

| | | Ex. 1 | Ex. 2 | Ex. 3 | Ex. 4 | Ex. 5 | Ex. 6 | Ex. 7 |
|---|---|---|---|---|---|---|---|---|
| Composition | SiO₂ | 60.7 | 60.7 | 59.6 | 62.5 | 60.7 | 60.7 | 60.7 |
| [mol %] | Al₂O₃ | 3.4 | 3.4 | 5.4 | 4.0 | 6.0 | 3.4 | 3.4 |
| | B₂O₃ | 3.9 | 3.9 | 3.9 | 5.0 | 4.0 | 3.9 | 3.9 |
| | MgO | 15.2 | 7.6 | 3.6 | 11.0 | 12.0 | 15.2 | 15.2 |
| | CaO | 0.0 | 0.0 | 0.0 | 0.0 | 0.0 | 0.0 | 0.0 |
| | TiO₂ | 0.0 | 0.0 | 0.0 | 0.0 | 0.0 | 0.0 | 0.0 |
| | ZrO₂ | 2.5 | 2.5 | 2.5 | 0.0 | 0.0 | 2.5 | 2.5 |
| | Li₂O | 0.0 | 0.0 | 0.0 | 0.0 | 0.0 | 0.0 | 0.0 |
| | Na₂O | 9.3 | 9.3 | 9.3 | 9.0 | 10.0 | 9.3 | 9.3 |
| | K₂O | 0.0 | 0.0 | 0.0 | 0.0 | 0.0 | 0.0 | 0.0 |
| | P₂O₅ | 5.1 | 5.1 | 6.1 | 3.5 | 3.3 | 5.1 | 5.1 |
| | BaO | 0.0 | 7.6 | 5.6 | 5.0 | 4.0 | 0.0 | 0.0 |
| | SrO | 0.0 | 0.0 | 0.0 | 0.0 | 0.0 | 0.0 | 0.0 |
| | Nb₂O₅ | 0.0 | 0.0 | 4.0 | 0.0 | 0.0 | 0.0 | 0.0 |
| | ZnO | 0.0 | 0.0 | 0.0 | 0.0 | 0.0 | 0.0 | 0.0 |

| Type | Phase-separated glass | | | | | | |
|---|---|---|---|---|---|---|---|
| Phase separation | 1,420 | 1,360 | 1,350 | 1,280 | 1,200 | 1,420 | 1,420 |
| treatment | | | | | | | |
| temperature [° C.] | | | | | | | |
| Specific gravity | 2.49 | 2.88 | 2.79 | 2.61 | 2.59 | 2.49 | 2.49 |
| [g/cm³] | | | | | | | |
| Tg[° C.] | 614 | 603 | 623 | 597 | 600 | 614 | 614 |
| Yield point [° C.] | 738 | 723 | 774 | 689 | | 738 | 738 |

| | | Ex. 8 | Ex. 9 | Ex. 16 | Ex. 17 | Ex. 18 | Ex. 19 |
|---|---|---|---|---|---|---|---|
| Composition | SiO₂ | 60.7 | 60.7 | 60.3 | 61.5 | 69.8 | 69.7 |
| [mol %] | Al₂O₃ | 3.4 | 3.4 | 3.7 | 4.5 | 2.2 | 2.3 |
| | B₂O₃ | 3.9 | 3.9 | 16.0 | 20.0 | 16.0 | 8.0 |
| | MgO | 7.6 | 7.6 | 5.0 | 3.0 | 3.0 | 5.0 |
| | CaO | 0.0 | 0.0 | 5.0 | 8.0 | 3.0 | 5.0 |
| | TiO₂ | 0.0 | 0.0 | 0.0 | 0.0 | 0.0 | 0.0 |
| | ZrO₂ | 2.5 | 2.5 | 0.0 | 0.0 | 0.0 | 0.0 |
| | Li₂O | 0.0 | 0.0 | 0.0 | 0.0 | 0.0 | 0.0 |
| | Na₂O | 9.3 | 9.3 | 0.0 | 0.0 | 0.0 | 0.0 |
| | K₂O | 0.0 | 0.0 | 0.0 | 0.0 | 0.0 | 0.0 |
| | P₂O₅ | 5.1 | 5.1 | 0.0 | 0.0 | 0.0 | 0.0 |
| | BaO | 7.6 | 7.6 | 5.0 | 0.0 | 3.0 | 5.0 |
| | SrO | 0.0 | 0.0 | 5.0 | 3.0 | 3.0 | 5.0 |
| | Nb₂O₅ | 0.0 | 0.0 | 0.0 | 0.0 | 0.0 | 0.0 |
| | ZnO | 0.0 | 0.0 | 0.0 | 0.0 | 0.0 | 0.0 |

| Type | Phase-separated glass | | | | | |
|---|---|---|---|---|---|---|
| Phase separation | 1,360 | 1,360 | 1,141 | 1,183 | 1,300 | 1,312 |
| treatment | | | | | | |
| temperature [° C.] | | | | | | |
| Specific gravity | 2.88 | 2.88 | 2.65 | 2.40 | 2.44 | 2.68 |
| [g/cm³] | | | | | | |
| Tg[° C.] | 603 | 603 | | 647 | 657 | |
| Yield point [° C.] | 723 | 723 | | 756 | 707 | |

TABLE 2

| | Ex. 1 | Ex. 2 | Ex. 3 | Ex. 4 | Ex. 5 | Ex. 6 | Ex. 7 | Ex. 8 | Ex. 9 | Ex. 16 | Ex. 17 | Ex. 18 | Ex. 19 |
|---|---|---|---|---|---|---|---|---|---|---|---|---|---|
| Thermal | 72 | 73 | 68 | 73 | 79 | 72 | 72 | 73 | 73 | | 42 | 44 | |
| expansion | | | | | | | | | | | | | |
| coefficient | | | | | | | | | | | | | |
| [10⁻⁷/° C.] | | | | | | | | | | | | | |
| Young's modulus | 75 | 74 | 72 | 71 | | 75 | 75 | 74 | 74 | 78 | 72 | 70 | 83 |
| [GPa] | | | | | | | | | | | | | |
| Vickers | | 615 | | 615 | | | | 615 | 615 | | | | |
| hardness[HV0.2] | | | | | | | | | | | | | |
| Bending strength | | 124 | 124 | 127 | | | | 124 | 124 | | | | |
| [MPa] | | | | | | | | | | | | | |
| Surface resistance | — | — | — | 6.1 × 10¹² | — | | | | | | | | |
| (Ω/□) | | | | | | | | | | | | | |
| Haze (%) | 97.0 | 97.0 | 97.0 | 97.0 | 97.0 | | | | | | | | |
| Total light | 46 | 21 | | | 31 | | | | | 27 | 18 | 20 | 28 |
| transmittance [%] | | | | | | | | | | | | | |
| 1 mm λ = 450 nm | | | | | | | | | | | | | |
| Total light | 47 | 24 | | | 33 | | | | | 25 | 16 | 17 | 26 |
| transmittance [%] | | | | | | | | | | | | | |
| 1 mm λ = 550 nm | | | | | | | | | | | | | |
| Total light | 48 | 26 | | | 36 | | | | | 28 | 19 | 22 | 28 |
| transmittance [%] | | | | | | | | | | | | | |
| 1 mm λ = 630 nm | | | | | | | | | | | | | |

TABLE 3

| | | Ex. 1 | Ex. 2 | Ex. 3 | Ex. 4 | Ex. 5 | Ex. 6 | Ex. 7 | Ex. 8 | Ex. 9 | Ex. 16 | Ex. 17 | Ex. 18 | Ex. 19 |
|---|---|---|---|---|---|---|---|---|---|---|---|---|---|---|
| Tt[%]5 mm | | | | | 15 | | | | | | | | | |
| Tt[%]1 mm | | 47 | 24 | | | 33 | | | | | 27 | 18 | 20 | 27 |
| Rt[%]1 mm | | 52 | 75 | | | 67 | | | | | 73 | 81 | 79 | 72 |
| Tt + Rt[%]1 mm | | 99 | 99 | | | 100 | | | | | 100 | 99 | 99 | 99 |
| Ts[%]1 mm | | 0.5 | 0.2 | | | 0.4 | | | | | 0.3 | 0.3 | 0.3 | 0.3 |
| I₃₀/I₀[—]1 mm | | 0.93 | | | | 0.90 | | | | | 0.82 | 0.81 | 0.80 | 0.81 |
| λ = 550 nm | | | | | | | | | | | | | | |
| Water absorption | | <0.001 | <0.001 | | <0.001 | <0.001 | | | <0.001 | <0.001 | | <0.001 | <0.001 | |
| rate [%] | | | | | | | | | | | | | | |
| Average value Dₐ | | | 300 | | | 100 | | | | | 2000 | 800 | 1500 | 3000 |
| [nm] | | | | | | | | | | | | | | |
| Average value Dₗ | | | 1500 | | | 600 | | | | | 3000 | 1000 | 2000 | 4000 |
| [nm] of upper | | | | | | | | | | | | | | |
| 10% | | | | | | | | | | | | | | |
| Average value D_{S} | | | 100 | | | 80 | | | | | 100 | 100 | 100 | 300 |
| [nm] of lower | | | | | | | | | | | | | | |
| 10% | | | | | | | | | | | | | | |
| Dₗ − D_{S}[nm] | | | 1400 | | | 520 | | | | | 2900 | 900 | 1900 | 3700 |
| Color | L* | 94.5 | 96.17 | | | 96.33 | | | | | | | | |
| | a* | −0.6 | −0.32 | | | −0.45 | | | | | | | | |
| | b* | −0.11 | −0.02 | | | 1.34 | | | | | | | | |
| | (a*² + b*²)^{1/2} | 0.61 | 0.32 | | | 1.41 | | | | | | | | |

| | | | | | | | | | | | | | |
|---|---|---|---|---|---|---|---|---|---|---|---|---|---|
| A | 47 | 24 | | | 33 | | | | | 27 | 18 | 20 | 27 |
| Visual evaluation | A | A | A | A | A | A | A | A | A | A | A | A | A |
| of diffusibility | | | | | | | | | | | | | |

TABLE 4

| | | Ex. 10 | Ex. 11 | Ex. 12 | Ex. 13 | Ex. 14 | Ex. 15 | Ex. 20 | Ex. 21 | Ex. 22 |
|---|---|---|---|---|---|---|---|---|---|---|
| Com- | SiO₂ | 50.4 | 72.0 | 63.6 | 49.1 | 61.1 | 52.2 | 63.8 | 64.1 | 10.9 |
| posi- | Al₂O₃ | 22.7 | 14.1 | 4.4 | 13.9 | 4.7 | 10.2 | 16.5 | 16.5 | 3.2 |
| tion | B₂O₃ | 0.0 | 0.0 | 0.9 | 7.0 | 0.8 | 2.3 | | | |
| [mol | MgO | 0.0 | 0.0 | 0.0 | 8.1 | 18.9 | 19.5 | 1.7 | 0.9 | 0.0 |
| %] | CaO | 0.0 | 0.0 | 19.6 | 3.6 | 4.4 | 4.7 | 1.3 | 1.2 | 0.0 |
| | TiO₂ | 6.9 | 1.6 | 0.0 | 2.2 | 1.3 | 6.5 | 3.5 | 2.6 | 26.4 |
| | ZrO₂ | 0.0 | 1.1 | 0.0 | 0.8 | 2.5 | 0.0 | 1.1 | 1.1 | 0.0 |
| | Li₂O | 0.0 | 8.8 | 0.0 | 0.0 | 1.0 | 0.0 | 5.9 | 8.2 | 35.3 |
| | Na₂O | 12.5 | 1.1 | 3.1 | 8.8 | 4.8 | 0.0 | | | |
| | K₂O | 7.5 | 0.0 | 1.4 | 3.0 | 0.0 | 0.0 | | | |
| | P₂O₅ | 0 | 0.5 | 0.0 | 0.0 | 0.4 | 0.0 | 0.0 | 3.7 | 16.4 |
| | BaO | 0.0 | 0.9 | 1.7 | 0.0 | 0.0 | 0.0 | 0.9 | 0.5 | 0.0 |
| | SrO | 0.0 | 0.0 | 0.0 | 0.0 | 0.0 | 0.0 | 1.4 | 0.0 | 0.0 |
| | Nb₂O₅ | 0.0 | 0.0 | 0.0 | 0.0 | 0.0 | 0.0 | | | |
| | ZnO | 0.0 | 0.0 | 5.2 | 3.4 | 0.0 | 4.7 | 3.5 | 0.9 | 0.0 |
| | GeO₂ | | | | | | | 0.0 | 0.3 | 7.7 |
| | La₂O₃ | | | | | | | 0.4 | | |

| Type | Crystallized glass | | | | | | | | |
|---|---|---|---|---|---|---|---|---|---|
| Crystal | Nepheline | Spodumene | β- | Forsterite | Enstatite | Enstatite | β | β | Li_{1+x+y}AlₓTi₂₋ₓ |
| phase | ((Na,K)AlSiO₄) | (LiAlSi₂O₆) | wollas- | (2MgO•SiO₂) | (MgSiO₃) | (MgSiO₃) | quartz | quartz | SiP_{3-y} |
| | | | tonite | garnite | diopside | garnite | solid | solid | |
| | | | (CaO•SiO₂) | (ZnO•Al₂O₃) | (MgCaSi₂O₆) | (ZnO•Al₂O₃) | | | |
| | | | | | | rutile (TiO₂) | | | |

TABLE 5

| | Ex. 10 | Ex. 11 | Ex. 12 | Ex. 13 | Ex. 14 | Ex. 15 | Ex. 20 | Ex. 21 | Ex. 22 |
|---|---|---|---|---|---|---|---|---|---|
| Crystallization | | Nuclei | 1,100° C., | 1,000° C., | 1,050° C., | 1,000° C., | 700° C., | 700° C., | 650° C., |
| conditions | | generation | 1 hour | 1 hour | 1 hour | 1 hour | 10 hours | 40 hours | 10 hours |
| | | 750° C. to | | | | | 900° C., | 900° C., | 895° C., |
| | | 800° C. | | | | | 10 hours | 10 hours | 20 hours |
| | | Crystal | | | | | | | |
| | | growth | | | | | | | |
| | | 1,100° C. to | | | | | | | |
| | | 1,200° C. | | | | | | | |
| Crystallization | | | 30 | | 34 to 36 | 31 to 33 | | | |
| ratio [%] | | | | | | | | | |
| Specific gravity | 2.68 | 2.52 | 2.70 | 2.50 | 2.76 | 2.91 | | | |
| [g/cm³] | | | | | | | | | |
| Thermal | 129 | 12 | 62 | 73 | 79 | 62 | | | |
| expansion | | | | | | | | | |
| coefficient | | | | | | | | | |
| [10⁻⁷/° C.] | | | | | | | | | |
| Young's modulus | 87 | 89 | 86 | | 95 | 111 | 98 | 90 | 71 |
| [GPa] | | | | | | | | | |
| Vickers | | 720 | 530 | 580 | | | | | |
| hardness[HV0.2] | | | | | | | | | |
| Bending strength | 123 | 170 | 50 | 59 | | 192 | | | |
| [MPa] | | | | | | | | | |

TABLE 6

| | Ex. 10 | Ex. 11 | Ex. 12 | Ex. 13 | Ex. 14 | Ex. 15 | Ex. 20 | Ex. 21 | Ex. 22 |
|---|---|---|---|---|---|---|---|---|---|
| Total light | | 1 | | | | | >70 | >70 | |
| transmittance [%] | | | | | | | | | |
| 1 mm λ = 450 nm | | | | | | | | | |
| Total light | | 1 | | | | | >70 | >70 | |
| transmittance [%] | | | | | | | | | |
| 1 mm λ = 550 nm | | | | | | | | | |
| Total light | | 2 | | | | | >70 | >70 | |
| transmittance [%] | | | | | | | | | |
| 1 mm λ = 630 nm | | | | | | | | | |
| Tt[%]1 mm | | 1 | | | | | >70 | >70 | |
| Rt[%]1 mm | | 99 | | | | | | | |
| Tt + Rt[%]1 mm | | 100 | | | | | | | |
| Ts[%]1 mm | | <0.1 | | | | | | | |
| I₃₀/I₀[—]1 mm | | 0.95 | | | | | | | |
| λ = 550 nm | | | | | | | | | |
| Water absorption | <0.001 | <0.001 | <0.001 | <0.001 | <0.001 | <0.001 | | | |
| rate [%] | | | | | | | | | |
| Average value Dₐ | | 1000 | | | | | 100 | 300 | 400 |
| [nm] | | | | | | | | | |
| Average value Dₗ | | 2000 | | | | | | | |
| [nm] of upper | | | | | | | | | |
| 10% | | | | | | | | | |
| Average value D_{S} | | 100 | | | | | | | |
| [nm] of lower | | | | | | | | | |
| 10% | | | | | | | | | |
| Dₗ − D_{S}[nm] | | 1900 | | | | | | | |
| Visual evaluation | A | A | A | A | A | A | B | B | |
| of diffusibility | | | | | | | | | |

As shown in Tables 1 to 6, each glass of Examples 1 to 19 exhibited excellent heat resistance and rigidity. On the other hand, as a comparative example, a light diffusion plate made of a polystyrene resin was prepared and the physical properties thereof were evaluated. As a result, the surface resistance was 7.9×10¹⁵Ω/□, the haze was 97.0%, and the total light transmittance (1 mm) was 63%.

It was found that the diffusion performance of the glass of Examples 20 and 21 was insufficient as a light diffusion plate. Example 22 was colored yellow since the content of TiO₂ was large and there was a problem of absorbing violet to blue light.

Therefore, it was found that since the light diffusion plate of the present invention contains a glass plate having high heat resistance, it is possible to shorten the distance between the light source and the light diffusion plate in the case of being used in a direct type backlight unit and thus, it is easy to achieve brightness homogeneity. In addition, it was found that since the light diffusion plate of the present invention contains a glass plate, it is superior in the rigidity to that of a resin-made light diffusion plate.

Furthermore, as shown in FIG. 2 and FIGS. 3A, 3B and 3C, Examples 6 and 7 which are a glass containing coloring components exhibited the same transmittance wavelength dependency and transmitted light distribution as those of Example 1 which is a glass containing no coloring component. From these results, it was found that glass containing a coloring component can be used in the light diffusion plate of the present invention in the same manner as glass containing no coloring component as long as the concentration of the coloring component is within the allowable range.

While the present invention has been described in detail with reference to specific embodiments, it will be apparent to those skilled in the art that various changes and modifications can be made without departing from the spirit and scope of the present invention. This application is based on a Japanese patent application (Japanese Patent Application No. 2015-112646) filed on Jun. 2, 2015, the entirety of which is incorporated by reference. In addition, all references cited herein are incorporated in their entirety.

### DESCRIPTION OF REFERENCE NUMERALS AND SIGNS

1 DIRECT TYPE BACKLIGHT
2 REFLECTING PLATE
3 LIGHT SOURCE
4 LIGHT DIFFUSION PLATE
5 LIGHT DIFFUSION SHEET
6 PRISM SHEET
7 POLARIZED LIGHT SEPARATION SHEET

1. A light diffusion plate comprising a glass plate having a first main surface and a second main surface opposed to the first main surface,
wherein the glass plate has a thermal expansion coefficient of −100×10⁻⁷/° C. or more and 500×10⁻⁷/° C. or less, and light incident on the first main surface is transmitted from the second main surface while being diffused.

2. The light diffusion plate according to claim 1,
wherein the glass plate has a haze of 90% or more when incident light to the first main surface in a normal direction is transmitted through the glass plate, and has a ratio I₃₀/I₀ being 0.6 or more, of a transmittance I₀ at a wavelength of 550 nm of transmitted light in an incident direction and a transmittance I₃₀ at a wavelength of 550 nm of transmitted light in a direction tilted by 30° with respect to the incident direction.

3. The light diffusion plate according to claim 1,
wherein the glass plate comprises light scatterers having an average particle diameter of 50 nm or more and 10,000 nm or less in an interior thereof, and
the light scatterers have a difference (Dl−Ds) being 100 nm or more, between an average value Ds of a lower 10% and an average value Dl of an upper 10% of a particle diameter in a frequency distribution of scattering particles of the light scatterers in a particle diameter of 50 nm or more.

4. The light diffusion plate according to claim 1,
wherein the light scatterers occupy a volume fraction of 5% or more in the glass plate.

5. The light diffusion plate according to claim 1,
wherein the glass plate has, for incident light to the first main surface in the normal direction, a sum (Tt+Rt) being 90% or more, of an average value Tt of a total light transmittance and a total light reflectance Rt at a wavelength of from 400 nm to 700 nm of light transmitted in the incident direction.

6. The light diffusion plate according to claim 5,
wherein the glass plate has (a*²+b*²)^{1/2} of 10 or less in a 1976 CIE L*a*b* color system under a D65 light source.

7. The light diffusion plate according to claim 1,
wherein the glass plate has a water absorption rate of less than 0.1% based on JIS K7209 (2000).

8. The light diffusion plate according to claim 1,
wherein the glass plate has a glass transition point Tg of 200° C. or higher and 850° C. or lower.

9. The light diffusion plate according to claim 1,
wherein the glass plate has a Young's modulus of 10 GPa or more and 500 GPa or less.

10. The light diffusion plate according to claim 1,
wherein the glass plate has a Vickers hardness Hv of 300 or more and 900 or less.

11. The light diffusion plate according to claim 1,
wherein the glass plate has a surface resistance value of 1.0×10¹⁵Ω/□ or less.

12. The light diffusion plate according to claim 1,
wherein the glass plate comprises, as indicated by molar percentages in terms of oxides, from 40% to 80% of SiO₂, from 0% to 35% of Al₂O₃, from 0% to 30% of MgO, from 0% to 30% of Na₂O, and from 0% to 15% of P₂O₅.

13. The light diffusion plate according to claim 12,
wherein the glass plate further comprises, as ppm by weight in terms of oxides, from 1 to 2,000 ppm of Fe₂O₃ and from 0.01 to 30 ppm of CoO.

14. The light diffusion plate according to claim 1,
wherein the glass plate has, for incident light to the first main surface in a normal direction, an average value being 4% or more, of a total light transmittance at a wavelength of from 400 nm to 700 nm transmitted in the incident direction.

15. The light diffusion plate according to claim 1,
wherein the glass plate has a total light reflectance being 10% or more, in a wavelength range of from 400 nm to 700 nm for a plate thickness of 1 mm when incident light from the normal direction to the first main surface is transmitted through the glass plate.

16. The light diffusion plate according to claim 1,
wherein the glass plate has a transmittance being 0.2% or more and 10% or less, at a wavelength of from 400 nm to 700 nm of transmitted light in a direction tilted by 30⁰ with respect to the incident direction.

17. The light diffusion plate according to claim 1,
wherein the glass plate has a plate thickness of 0.05 mm or more and 3 mm or less.

18. The light diffusion plate according to claim 1,
wherein the glass plate has a dimension with at least one side of 200 mm or more.
